(19) United States
(12) Patent Application Publication
(10) Pub. No.: US 2014/0240833 A1
(43) Pub. Date: Aug. 28, 2014

(54) CORNER REFLECTOR

(71) Applicant: Dieter Kuhnke, Luebbecke (DE)

(72) Inventor: Dieter Kuhnke, Luebbecke (DE)

(73) Assignee: GUS PRAEZISION IN KUNSTOFF, GLAS UND GMBH & CO. KG, LUEBBECKE (DE)

(21) Appl. No.: 14/125,441

(22) PCT Filed: Apr. 10, 2013
(86) PCT No.: PCT/DE2013/100131

§ 371 Date: Dec. 11, 2013

(30) Foreign Application Priority Data
Apr. 11, 2012 (DE) 102012103098.7

(51) Int. Cl. G02B 5/122

(52) U.S. Cl. CPC G02B 5/122
USPC 359/529

(57) ABSTRACT

A corner reflector (e.g. a periscope) is made of a prism block having a viewing-in end and a viewing-out end with mirrored inclined surfaces or deflection mirrors applied on its inclined surfaces and also functional plates arranged in front of the viewing-in end and/or the viewing-out end. In the corner reflector, as far as possible, no signs of detachment of the deflection mirrors arranged thereon or of functional plates occur and which has an increased lifetime, which is achieved by all plate-shaped components, such as the deflection mirrors and the functional plates. All solid components of the corner reflector, such as the prism block, are made of plastic.

The invention relates to a corner reflector consisting of a prism block having a viewing-in end and a viewing-out end with mirrored inclined surfaces or deflection mirrors applied on its inclined surfaces and also functional plates arranged in front of the viewing-in end and/or the viewing-out end.

Known is an acrylic glass block for corner reflectors, DE 82 04 209 U1, which is provided on the viewing-in end and the viewing-out end with a silicate glass plate and with deflection mirrors on its inclined surfaces, which are applied thereon in an autoclave process using adhesive films arranged therebetween.

Over the lifetime of such a known corner reflector, said corner reflector is exposed to frequent temperature changes and to a great variety of other weather influences, such that signs of detachment of the applied deflection mirrors or functional plates can occur, which will subsequently degrade the function of the corner reflector or render it entirely unusable.

It is the object of the invention to make available a corner reflector, in which, as far as possible, no signs of detachment of the deflection mirrors arranged thereon or of functional plates occur and which also has an increased lifetime.

The object is achieved in conjunction with the features of the preamble according to the invention together with the technical features of the characterizing part of the main claim in particular by all plate-shaped components, such as the deflection mirrors and the functional plates, and all solid components of the corner reflector, such as the prism block, being made of plastic. This has the particular advantage that the stresses to be absorbed by the connection layer are much smaller than would be the case for example in a combination of plastic and silicate glass.

Further advantageous developments of the subject matter of the invention can be gathered by and in combination from the further dependent claims.

According to a particularly preferred embodiment of the inventive corner reflector, all plate-shaped and all solid components are made of plastic materials which in each case have identical coefficients of thermal expansion, such that signs of detachment of deflection mirrors or functional plates from the prism block of a corner reflector that are caused by thermal expansion can no longer occur.

Another advantage of using plastic materials is that a corner reflector constructed therewith obviously also has a lower weight than a corner reflector equipped with silicate glass panes of functional plates and silicate deflection mirrors. According to a particularly preferred exemplary embodiment of the inventive corner reflector, all its plate-shaped and solid components are composed of optical PMMA, which for example can have a coefficient of thermal expansion of 70×10⁻⁶ K⁻¹, whereas quartz glass, for example, has a coefficient of thermal expansion of 5×10⁻⁶ K⁻¹, that is to say a much lower coefficient of thermal expansion.

In order to entirely rule out such signs of detachment and degradation of a corner reflector caused by thermal expansion from the beginning, the prism block advantageously consists of only a single cast PMMA block, such that, as a result, permanent function of the corner reflector overall can be ensured.

Furthermore advantageous is an embodiment of the inventive corner reflector in which the plate-shaped components are attached to the prism block using an autoclave-free manufacturing process, such as by using an adhesive, such that it is also possible to drastically reduce the manufacturing costs of the inventive corner reflector without a loss in quality.

An exemplary embodiment of the invention will be described in more detail below with reference to figures. In the figures:

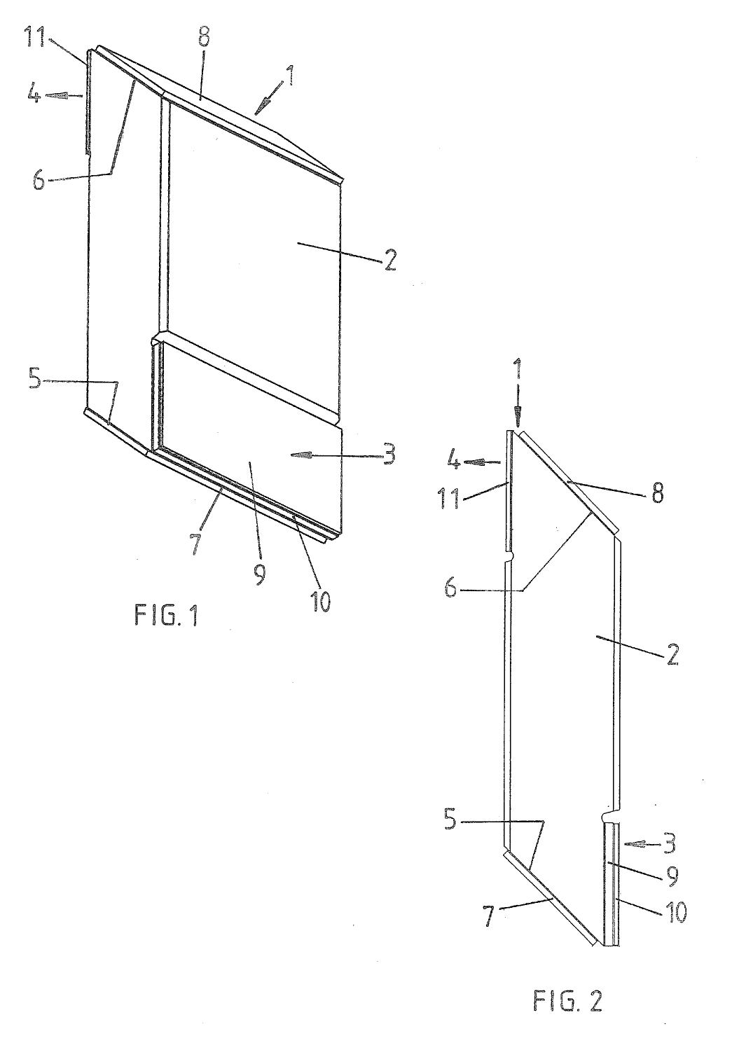

FIG. 1 shows an isometric view of a corner reflector, and

FIG. 2 shows a side view of the corner reflector according to FIG. 1.

The corner reflector 1 consists of a prism block 2, having a viewing-in end 3 and a viewing-out end 4, and of deflection mirrors 7, 8 applied on its inclined surfaces 5, 6 and also functional plates 9, 10, 11 arranged in front of its viewing-in end 8 and in front of its viewing-out end 4. The deflection mirrors 7, 8 and the functional plates 9, 10, 11 are attached to the prism block 2 by way of adhesive films, such as PU films, wherein the functional plate 9, for example, can be configured as a laser protection filter and the functional plate 10 can be equipped with a plate heating means, just as the functional plate 11 on the viewing-out end 4 of the corner reflector 1. The prism block 2 of the corner reflector 1 consists of a PMMA block, which is cast in one piece, just like the deflection mirrors 7, 8 and the functional plates 9, 10, 11 are made of PMMA.

1-5. (canceled)

6. A corner reflector, comprising:
a prism block having a viewing-in end, a viewing-out end and inclined surfaces; and
plate shaped components including deflection mirrors disposed on said inclined surfaces and functional plates disposed in front of at least one of said viewing-in end or said viewing-out end, said plate-shaped components and said prism block being made of plastic, said plate-shaped components and said prism block composed of plastic materials which in each case have identical coefficients of thermal expansion, and in that all said plate-shaped components and said prism block are composed of optical polymethylmethacrylate (PMMA).

7. The corner reflector according to claim 6, wherein said prism block is configured in one piece.

8. The corner reflector according to claim 6, further comprising an adhesive, said plate-shaped components are attached to said prism block using an autoclave-free manufacturing process and said adhesive.

9. A corner reflector, comprising:
a prism block having a viewing-in end, a viewing-out end and mirror inclined surfaces; and
plate shaped components including functional plates disposed in front of at least one of said viewing-in end or said viewing-out end, said plate-shaped components and said prism block being made of plastic, said plate-shaped components and said prism block composed of plastic materials which in each case have identical coefficients of thermal expansion, and in that all said plate-shaped components and said prism block are composed of optical polymethylmethacrylate (PMMA).
